(19) United States
(12) Patent Application Publication
(10) Pub. No.: US 2008/0127455 A1
(43) Pub. Date: Jun. 5, 2008

(54) Sliding Hinge Device, Personal Portable Device Having the Sliding Hinge Device and Method of Manufacturing the Sliding Hinge Device

(75) Inventor: Sang Ho Lee, Daegu (KR)

Correspondence Address: MILLER NASH LLP, 601 UNION STREET, SUITE4400, SEATTLE, WA, 98101-2352, US

(73) Assignee: SHELL-LINE CO., LTD., Gyeongsangbuk-do (KR)

(21) Appl. No.: 11/813,989

(22) PCT Filed: Oct. 24, 2005
(86) PCT No.: PCT/KR05/03533

§ 371 Date: Jul. 13, 2007

(30) Foreign Application Priority Data
Jan. 14, 2005 (KR) 10-2005-0003879
Mar. 21, 2005 (KR) 10-2005-0023132

(51) Int. Cl. E05D 11/06; H04B 1/38; E05D 11/02; E05D 7/00

(52) U.S. Cl. 16/225; 16/357; 184/5

(57) ABSTRACT

A slide hinge device installed between two terminal bodies opening and closing by sliding is provided. The slide hinge unit includes: a rail hinge unit including an upper supporter, a lower supporter separated from the upper supporter by a pre-determined distance, and at least one guide bar bound with the upper supporter and the lower supporter; and a slide hinge unit, in which a penetration hole corresponding to the guide bar is formed, including a slide guide for sliding along the guide bar and a guide frame bound with the slide guide as one body.

### TECHNICAL FIELD

The present invention relates to a slide type personal portable device, and more particularly, to a slide type personal portable device, a slide hinge device mounted on the terminal, and a method of manufacturing the slide hinge device.

### BACKGROUND ART

Mobile phones may be generally divided into a flip type, a folder type, and a slide type, according to an external shape or operation method.

In a slide type phone, two sliding bodies are disposed while overlapped with each other and a display unit and key input unit are disposed in the same direction on the bodies, respectively. Generally, the slide type phone may exposure a display unit or key input unit on the rear by moving a front sliding body. For example, there is a slide type phone whose key input unit formed on a rear sliding body is exposed by pushing up a front sliding body. Also, there is a slide type phone whose display unit formed on a rear sliding body is exposed by moving downward a front sliding body on which a key input unit is formed.

A slide type mobile phone includes sliding bodies overlapped above and below. A slide hinge device connecting the both bodies is interposed between the sliding bodies to mutually connect the sliding bodies and enable the sliding bodies to slide. In association with a slide hinge device, hinge devices of various structures are disclosed. Among the disclosed hinge devices, there is a hinge device using a guide bar or shaft, whose bodies may precisely slide by using the guide bar.

FIG. 1 is a perspective view illustrating a conventional slide hinge device. Referring to FIG. 1, the conventional slide hinge device includes a guide rail element 110, a slide element 120 sliding on the guide rail element 110, and first and second torsion springs 130 and 140 promoting the sliding of the slide element 120.

The guide rail element 110 is formed of a rectangular board 112. First and second guide bars 150a and 150b are installed along both sides of the rectangular board 112 parallel to each other. The first and second guide bars 150a and 150b are separated from the both sides of the rectangular board 112 at a certain interval. Both ends of the first and second guide bars 150a and 150b are fastened to top and bottom supporters 114 and 116 of the rectangular board 112.

Also, top and bottom shock absorbing rubbers 152a to 152b′ are slipped on both top and bottom ends of the first and second guide bars 150a and 150b and both the top and bottom ends enter into the top and bottom supporters 114 and 116 and are fastened thereto. The top and bottom shock absorbing rubbers 152a to 152b′ are in the shape of a hat in order to cover the ends of the first and second guide bars 150a and 150b, prevent a direct collision between the guide rail element 110 and the slide element 120, and enable the first and second guide bars 150a and 150b installed along the guide rail element 110 in sliding of the slide element 120.

Two holes are formed adjacent to both outer edges of the rectangular board 112. An arm 132a of the first torsion spring 130 and an arm 142a of the second torsion spring 140 are inserted into the holes to rotate.

First and second guide sills 118a and 118b are formed on both sides of the rectangular board 112, opposite to the first and second guide bars 150a and 150b. In detail, the first guide sill 118a opposite to the first guide bar 150a and the second guide sill 118b opposite to the second guide bar 150b are formed as straight protrusions extended and protruded from the both sides of the rectangular board 112.

The slide element 120 may straightly slide on the guide rail element 110. For this, the slide element 120 includes first and second slide engagement portions 124a and 124b formed on both edges of a substrate 122. First and second guide holes 126a and 126b which the first and second guide bars 150a and 150b penetrate, respectively, are formed on the first and second slide engagement portions 124a and 124b. Two pairs of bearings are inserted into the first and second guide holes 126a and 126b to mitigate contact friction in sliding of the first and second guide bars 150a and 150b. The bearings are generally formed of polyoxymethylene (POM). The guide rail elements 110 do not directly make contact with the slide elements 120, an impact may be relieved, and noise may be reduced by using the bearings 127a to 127b′ and the shock absorbing rubbers 152a to 152b′.

First and second rails 128a and 128b protruded toward each other are formed inside the first and second slide engagement portions 124a and 124b. The first and second rails 128a and 128b are engaged with the first and second guide sills 118a and 118b to slide, respectively. In this case, since there is a gap between the first and second rails 128a and 128b and the first and second guide sills 118a and 118b, the rails 128a an 128b do not directly make contact with the guide sills 118a and 118b in sliding. In sliding, the first and second guide bars 150a and 150b and the first and second guide holes 126a and 126b mainly lead the sliding movement of the sliding bodies, and the first and second guide sills 118a and 118b and the first and second rails 128a and 128b assist to suppress a deviation or diversion of the slide element 120 such that the slide element 120 stably slides on the guide rail element 110.

After assembling the slide hinge device 100, an upper body and lower body of a mobile phone are screwed to the guide rail element 110 and the slide element 120, respectively, thereby completing a slide type mobile phone (not shown). Since a slide type mobile phone is generally used by holding a lower body with a hand and pushing up an upper body corresponding to a cover, a guide rail element fastened to the upper body may move on a slide element fastened to the lower body.

Generally, the guide rail element 110 and the slide element 120 are formed of aluminum and manufactured by die casting. Generally, the first and second guide bars 150a and 150b are formed separately from the guide rail element 110. Accordingly, the lower supporter 116 has a structure separated from the rectangular board 112 and is engaged with the rectangular board 112 by inserting the first and second guide bars 150a and 150b. Since the first and second guide holes 126a and 126b for containing the first and second guide bars 150a and 150b can not be formed by die casting, the first and second guide holes 126a and 126b have to be formed by an additional process of making a hole after manufacturing the slide element 120. Next, the bearings 127a to 127b′ formed of POM are additionally inserted.

A slide hinge device using a guide bar or shaft may enable a slide body to stably slide. However, by adding the guide bar structure, manufacturing of the hinge device becomes complicated, and by adding the hole-processing for the guide holes 126a and 126b, manufacturing cost or defect rate of a product may be increased.

### DISCLOSURE OF INVENTION

### Technical Goals

An aspect of the present invention provides a slide hinge device capable of being simply manufactured and a method of manufacturing the slide hinge device.

An aspect of the present invention provides a slide hinge device whose number of processes for manufacturing may be reduced and defect rate may be reduced and a method of manufacturing the slide hinge device.

### Technical Solutions

According to an aspect of the present invention, there is provided a slide hinge device including a rail hinge unit and a slide hinge unit.

The rail hinge unit includes an upper supporter, a lower supporter separated from the upper supporter by a predetermined distance, and at least one guide bar bound with the upper supporter and the lower supporter. The slide hinge unit includes a slide guide, in which a penetration hole corresponding to the guide bar is formed, for sliding along the guide bar and a guide frame bound with the slide guide as one body. The slide guide may further include a moving bush sliding along the guide bar and may be formed of lubricating material.

In a conventional slide hinge device having a guide bar, the guide bar has to be additionally assembled and, for this, an upper supporter or lower supporter is separately manufactured from a rail plate and the upper supporter or lower supporter has to be assembled by using a screw or other fastener after assembling the guide bar.

Also, since a slide hinge unit of the conventional slide hinge device is manufactured by die casting or injection molding, it is difficult to form a hole vertically penetrating the slide hinge unit and a guide hole must be formed via additional hole-processing. Though using extrusion molding, barrel polishing is required. Also, after forming the guide hole, a bearing formed of resin such as polyoxymethylene (POM) has to be inserted and mounted. Presently, since sizes of the guide hole and bearing are small, the guide hole and bearing must be formed manually.

However, in the slide hinge device according to the present invention, the upper supporter and lower supporter are directly molded on the guide bar, therefore an additional process of assembling the guide bar is not required, and since the upper supporter or lower supporter may be manufactured by a single molding process, the process of assembling may be omitted.

Also, since the rail hinge unit and the slide hinge unit may be molded by injection molding or die casting at the same time, an additional process of forming a hole or inserting a bearing may be omitted, thereby being convenient.

Also, since the rail hinge unit and the slide hinge unit are formed in a state in which the moving bush and the guide are combined, a position of a hole of the slide hinge unit may be automatically determined, thereby removing an error in dimensions.

According to another aspect of the present invention, there is provided a personal portable device including a first terminal body, a rail hinge unit, a slide hinge unit, and a second terminal body.

The first terminal body forms a body of the personal portable device; the rail hinge unit includes an upper supporter installed to the first terminal body, a lower supporter separated from the upper supporter by a predetermined distance, formed corresponding to the upper supporter, and installed onto the first terminal body, and at least one guide bar bound with the upper supporter and the lower supporter; a slide hinge unit includes a slide guide, in which a penetration hole corresponding to the guide bar in the center thereof, for sliding along the guide bar and a guide frame bound with the slide guide as one body, in which the slide guide and the guide frame may be molded at one time by insert injection molding; and a second terminal body is installed onto the guide frame and slides on the first terminal body.

In the present specification, a personal portable device indicates a portable electric/electronic device such as a Personal Digital Assistant (PDA), a smart phone, a handheld PC, a mobile phone, and an MP3 player, which may include a predetermined communication module such as a Code Division Multiple Access (CDMA) module, a Bluetooth module, an Infrared Data Association (IrDA) module, and a wired/wireless LAN card and may be used as a concept designating a terminal having a predetermined operation ability by including a predetermined microprocessor executing a function of replaying multimedia.

According to still another aspect of the present invention, there is provided a method of manufacturing a slide hinge device, the method including: providing a guide bar and a moving bush containing the guide bar, the moving bush capable of sliding along the guide bar; disposing the guide bar and the moving bush in a mold; and molding a rail hinge unit including an upper supporter and lower supporter containing both ends of the guide bar and a slide hinge unit containing the moving bush by using the mold. Accordingly, since the rail hinge unit the slide hinge unit may be manufactured by a single molding process, several molding processes and assembling processes may be omitted.

According to yet another aspect of the present invention, there is provided a method of manufacturing a slide hinge device, the method comprising: providing a guide bar and a slide guide, in which a penetration hole corresponding to the guide bar is formed, formed of lubricating material; disposing the guide bar and the slide guide in a first mold; molding an upper supporter and lower supporter containing both ends of the guide bar, by using the first mold; binding the upper supporter with the lower supporter by using a rail plate; and binding the slide guide with a guide frame as one body. Accordingly, the upper supporter and lower supporter are easily assembled via injection molding by using the first mold, and the rail plate is additionally connected, thereby enabling the rail plate to be thin.

### BRIEF DESCRIPTION OF DRAWINGS

FIG. 1 is a perspective view illustrating a conventional slide hinge device;

FIG. 2 is a perspective view illustrating a slide hinge device according to a first embodiment of the present invention;

FIG. 3 is a side view illustrating the slide hinge device of FIG. 2;

FIG. 4 is a partial perspective view illustrating the slide hinge device of FIG. 2;

FIG. 5 is a cross-sectional view illustrating a mold for the slide hinge device, according to the first embodiment of the present invention;

FIG. 6 is a control flow diagram illustrating a method of manufacturing the slide hinge device according to a first embodiment of the present invention;

FIG. 7 is a perspective view illustrating a personal portable device according to a second embodiment of the present invention;

FIG. 8 is an internal perspective view illustrating the personal portable device of FIG. 7;

FIG. 9 is an internal perspective view illustrating sliding of the personal portable device of FIG. 7;

FIG. 10 is a top view illustrating a slide hinge device according to a third embodiment of the present invention;

FIG. 11 is a perspective view of the slide hinge device of FIG. 10;

FIGS. 12 through 17 are perspective views or cross-sectional views illustrating a method of manufacturing and assembling the slide hinge device of FIG. 10;

FIG. 18 is a cross-section view illustrating a second mold for manufacturing slide guides according to an embodiment of the present invention;

FIG. 19 is a partial cross-sectional view illustrating a screw hole of the slide guide according to the third embodiment of the present invention;

FIG. 20 is a perspective view illustrating a slide hinge device according to another embodiment of the present invention; and

FIG. 21 is a cross-sectional view illustrating the slide hinge device of FIG. 20.

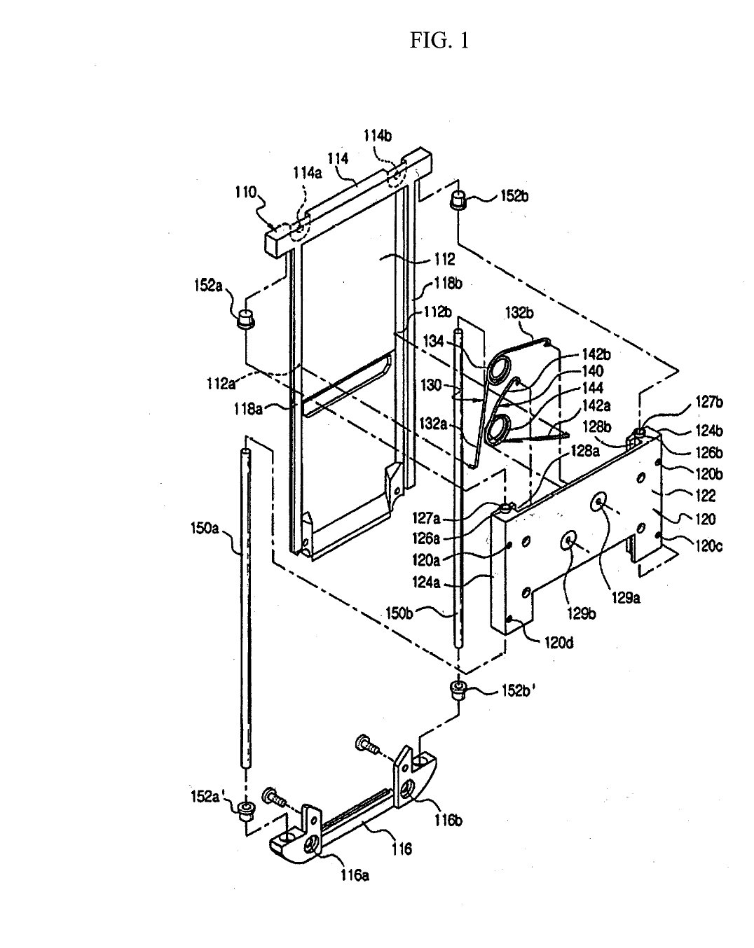

### BEST MODE FOR CARRYING OUT THE INVENTION

Hereinafter, embodiments of the present invention will be described in detail with reference to the attached drawings. However, the present invention is not limited or defined by the embodiments.

### Embodiment 1

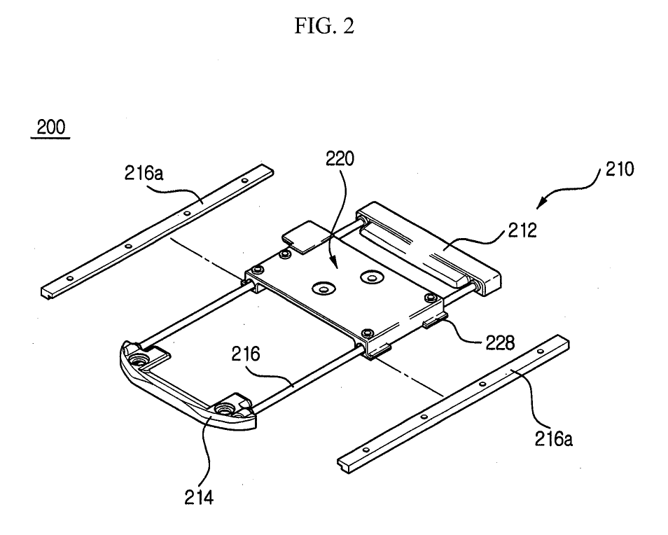

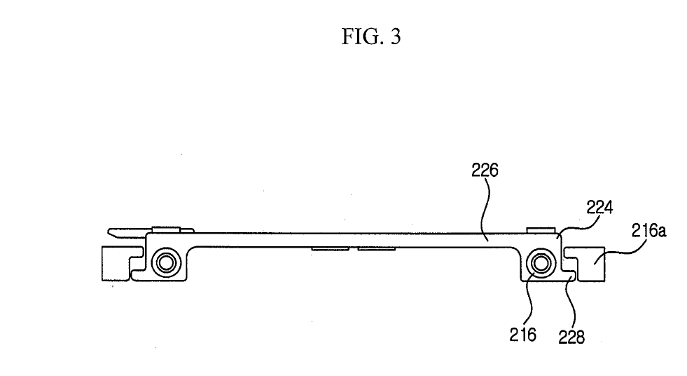

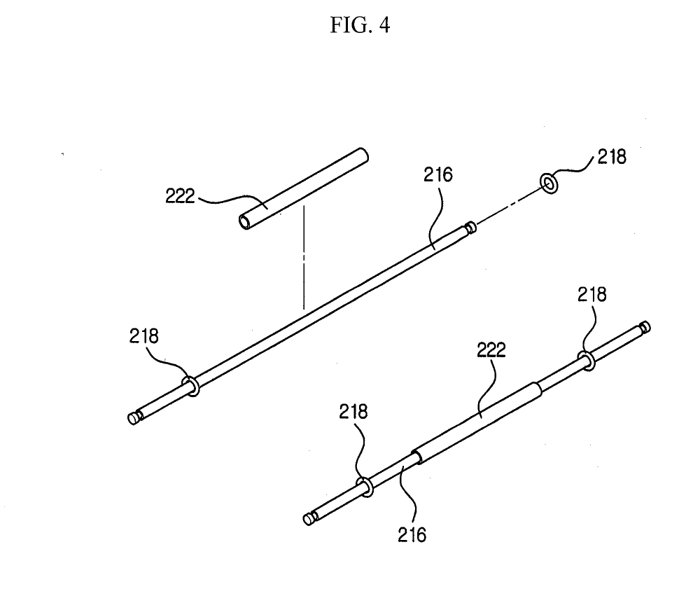

FIG. 2 is a perspective view illustrating a slide hinge device 200 according to a first embodiment of the present invention, FIG. 3 is a side view illustrating the slide hinge device 200 of FIG. 2, and FIG. 4 is a partial perspective view illustrating the slide hinge device 200 of FIG. 2.

Referring to FIGS. 2 through 4, the slide hinge device includes a rail hinge unit 210 and a slide hinge unit 220.

The rail hinge unit 210 includes an upper supporter 212, a lower supporter 214, and a guide bar 216. The upper supporter 212 is installed to a body of a slide type personal portable device, and the lower supporter 214 is separated from the upper supporter 212 at a length of the guide bar 216 and may be manufactured in a shape corresponding to the upper supporter 212. However, in other embodiments of the present invention, according to an intention of a designer, an upper supporter and a lower supporter may be formed in the same shape or in shapes different from each other. The guide bar 216 is interposed between the upper supporter 212 and the lower supporter 214, and both ends of the guide bar 216 are contained in and fixed to the upper supporter 212 and the lower supporter 214. Accordingly, slide hinge unit 220 may be formed on the guide bar 216 and may slide along the guide bar 216. The guide rail 216a is formed in the shape of a letter L along a longitudinal direction, adjacent to the guide bar 216.

Also, when the slide hinge device 200 is installed to a portable terminal, the guide rail 216a is installed onto the portable terminal to be disposed outside a guide protrusion 228. However, in other embodiments of the present invention, according to an intention of a designer, a guide rail and a portable terminal may be formed as one body. In this case, the guide rail 216a is for preventing the slide hinge unit 220 becoming separated from the rail hinge unit 210. When the slide hinge unit 220 normally moves, the guide rail 216a is separated from the slide hinge unit 220 at a predetermined interval.

Also, dampers 218 in the shape of a ring are provided adjacent to connection parts of the guide bar 216 and the upper supporter 212 and the guide bar 216 and the lower supporter 214. The dampers 218 are for preventing an impact and noise generated when a bump of the slide hinge unit 220 and the rail hinge unit 210. The damper 218 may have various cross-sections such as a circle or square. The damper 218 may be formed of crude rubber or other resins, such as conventional shock-absorbing rubber, having shock absorbing ability. Though the conventional shock-absorbing rubber is formed in the shape of a hat and covers the end of the guide bar 216, the dampers 218 of FIG. 4 are formed in the shape of a ring and may be controlled to be in a certain position on the guide bar 216.

An unevenness, such as a groove and a protrusion, may be formed at the end portions of the guide bar 216 to hold the upper and lower supporters such that the guide bar 216 is not separated from the upper supporter 212 and the lower supporter 214 after injection molding.

The slide hinge unit 220 includes a moving bush 222, a slide guide 224, and a guide frame 226. The moving bush 222 is formed in the shape of a tube capable of containing the guide bar 216 and may be formed of self-lubricant material such as brass. Since the slide guide 224 may be manufactured by casting or injection molding, the moving bush 222 disposed in a mold may be also formed of material having thermal resistance.

The slide guide 224 and the guide frame 226 are formed as one body around the moving bush 222. According to a manufacturing method according to the present invention, the slide guide 224 and the guide frame 226 may be manufactured via insert injection molding in one mold cavity. However, in other embodiments of the present invention, according to an intention of a designer, a slide guide and a guide frame with a moving bush may be formed as one body by other methods in addition to the casting or the injection molding. Counter to the guide rail 216a, the guide protrusions 228, in the shape of a letter L, are formed on both sides of the guide frame 226. Accordingly, the top of the guide protrusion 228 faces the bottom of the guide rail 216a, such that the guide protrusion 228 and the guide rail 216a may prevent the slide hinge unit 220 and the rail hinge unit 210 becoming separated from each other when the slide hinge unit 210 slides. However, in other embodiments of the present invention, according to an intention of the designer, a guide rail may be omitted. The guide protrusion 228 may be formed laterally and outwardly on a side of the slide guide 224. However, though discontinuously formed, the guide protrusion 228 may prevent the slide hinge unit 220 and the rail hinge unit 210 becoming separated from each other.

Accordingly, since the slide hinge unit 220 may be formed on the rail hinge unit 210 concurrently and the slide hinge unit 220 may slide along the guide bar 216 of the rail hinge unit 210, the slide hinge device 200 may be installed onto the slide type personal portable device. In this case, the slide type personal portable device indicates a personal portable device whose main body and slide body mutually slide to open and close.

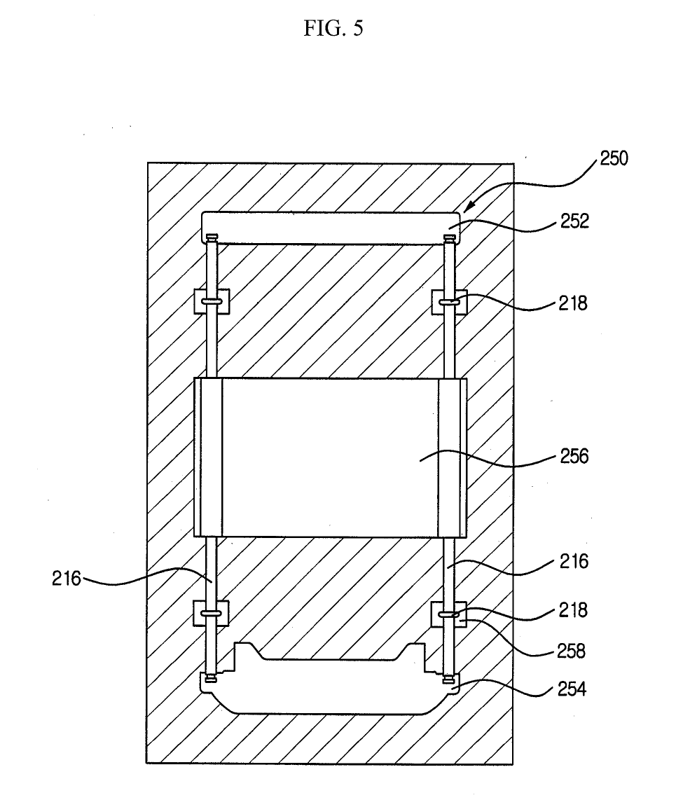

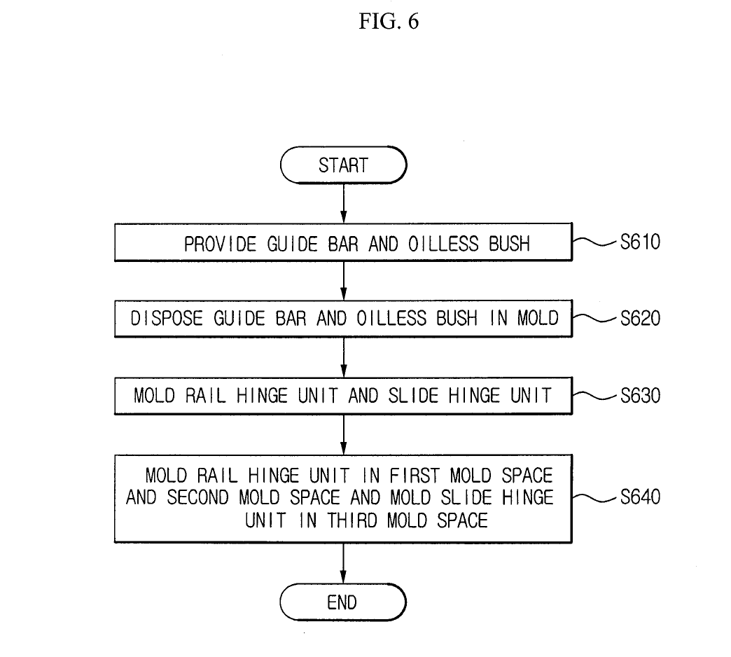

FIG. 5 is a cross-sectional view illustrating a mold for the slide hinge device, according to the first embodiment of the present invention, and FIG. 6 is a control flow diagram illustrating a method of manufacturing the slide hinge device according to the first embodiment of the present invention.

Referring to FIGS. 5 and 6, at least one guide bar 216 and the moving bush 222 (shown in FIG. 4) containing the guide bar 216 to slide together with the guide bar 216 are provided (S610). In this case, the guide bar 216 may be inserted into the hollow of the moving bush 222, and the moving bush 222 may be disposed at a certain position on the guide bar 216.

The guide bar 216 and the moving bush 222 slipped on the guide bar 216 are disposed in a mold 250 (S620). Referring to FIG. 5, the mold 250 may mold the upper supporter 212, the lower supporter 216, and the slide hinge unit 220. For this, the mold 250 includes a first mold space 252 for molding the upper supporter 212 and a second mold space 254 for molding the lower supporter 214, a third mold space 256 for molding the slide hinge unit 220. The first through third mold spaces 252, 254, and 256 are separated from each other, and the upper supporter 212, the lower supporter 214, and the slide hinge unit 220, separated from each other, may be molded via one process.

Also, the mold 250 includes a marginal space 258 located on the guide bar 216 for not molding but escaping the dampers 218, adjacent to the third mold space 256. The marginal space 258 is a space for temporarily protecting the damper 218 rather than a space for molding. At the beginning of a process of slipping the damper 218 on the guide bar 216, a position for disposing the damper 218 may be controlled such that the damper 218 is located in the marginal space 258.

The rail hinge unit 210 including the upper supporter 212 and the lower supporter 214 containing the both ends of the guide bar 216 and the slide hinge unit 220 containing the moving bush 222 are molded by using the mold 250 (S630). In this case, to mold the rail hinge unit 210 and the slide hinge unit 220, die casting or insert injection molding may be used. Accordingly, metal such as aluminum may be used in addition to engineering plastic (EP).

The first mold space 252 for the upper supporter 212, the second mold space 254 for the lower supporter 214, and the third mold space 256 for the slide hinge unit 220 are provided, and the first through third spaces 252, 254, and 256 are separated from each other. The rail hinge unit 210 and the slide hinge unit 220 are manufactured in the first through third mold spaces 252, 254, and 256 via one injection molding process (S640).

Accordingly, in the slide hinge device 200 according to the present invention, since the upper supporter 212, the lower supporter 214, and the slide hinge unit 220 are directly formed on the guide bar 216, an additional process of assembling the guide bar 216 is not required and the upper supporter 212, the lower supporter 214, and the slide hinge unit 220 are formed by a single molding process, thereby providing simple and convenient manufacturing.

Also, since the rail hinge unit 210 and the slide guide 220 are formed in a state in which the moving bush 222 and the guide bar 216 are bound with each other, a position of the hole of the slide guide 220 is automatically defined and there is no error in dimensions.

### Embodiment 2

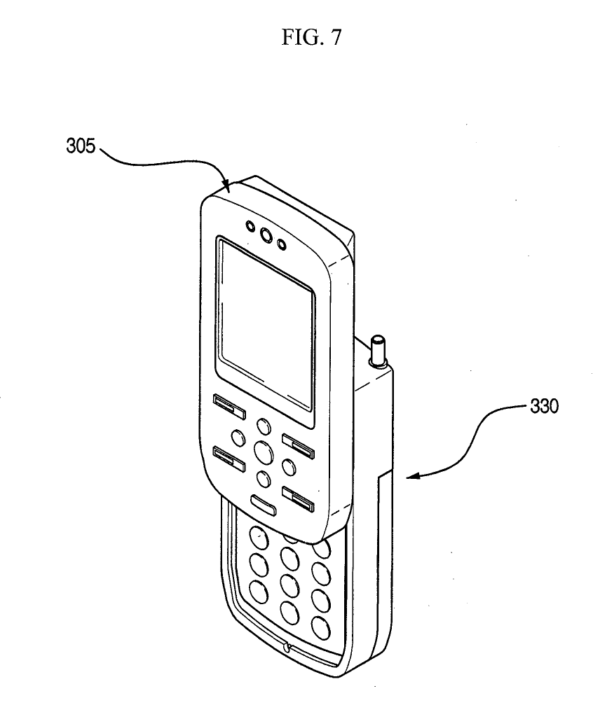

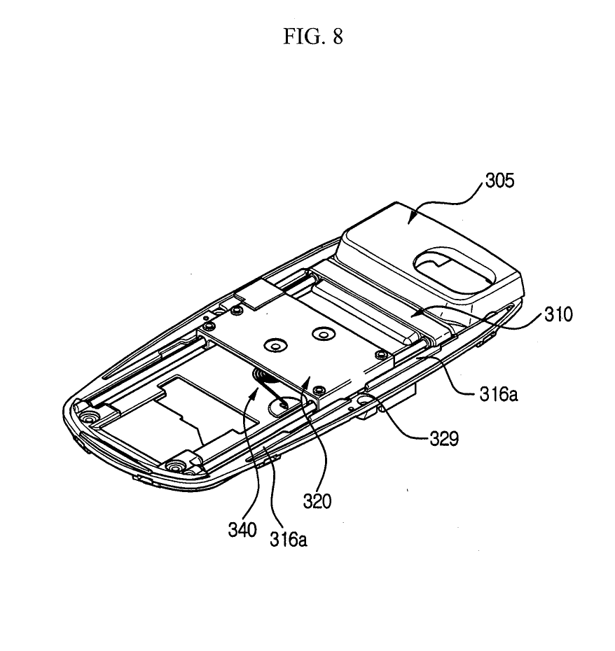

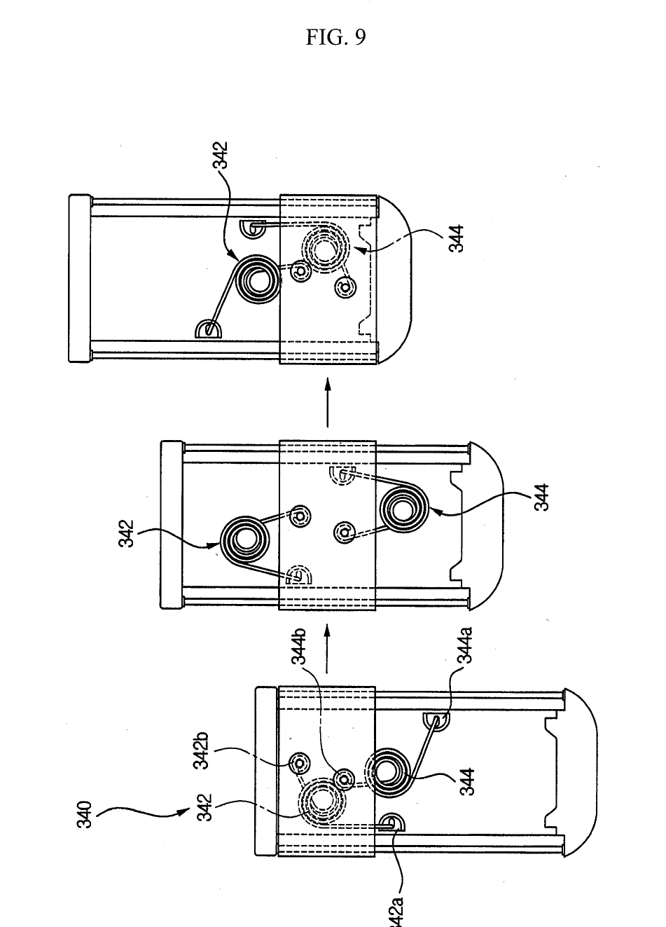

FIG. 7 is a perspective view illustrating a personal portable device according to a second embodiment of the present invention, FIG. 8 is an internal perspective view illustrating the personal portable device of FIG. 7, and FIG. 9 is an internal perspective view illustrating sliding of the personal portable device of FIG. 7.

Referring to FIGS. 7 through 9, the personal portable device includes a first terminal body 305, a rail hinge unit 310, a slide hinge unit 320, a second terminal body 330, and an elastic element 340.

In the slide type personal portable device, the rail hinge unit 310 and the slide hinge unit 320 are fixed to the terminal bodies, and the terminal bodies 305 and 330 may be open and closed by a slide type due to movement between the rail hinge unit 310 and the slide hinge unit 320 interposed between the terminal bodies 305 and 330. Generally, the rail hinge unit 310 is installed to a front terminal body 305 including a display unit and the slide hinge unit 320 is installed onto a rear terminal body 330 including a keypad and a battery.

The first terminal body 305 forms one of the terminal bodies and is bound with the rail hinge unit 310. The terminal bodies include components with general terminal functions and a circuit configuration. The terminal bodies may include a terminal case, a keypad, a display module, a wireless communication module, a battery, a microphone, and a receiver. Depending upon manufacturers, the internal configuration may be different. In the present invention, the terminal bodies includes the first terminal body 305 and the second terminal body 330, and a display module may be installed on the front of the first terminal 305 and a keypad and a battery may be installed in the second terminal body. However, in other embodiments of the present invention, according to an intention of a designer, a first terminal body and second terminal body may include other functions substituting for the functions or include various additional functions.

One end of the elastic element 340 is engaged with the slide hinge unit 320 and the other end of the elastic element 340 is engaged with the first terminal body 305, thereby the elastic element 340 can help semi-automatic opening and closing of the first terminal body 305 and the second terminal body 330. As shown in FIG. 8, the elastic element 340 interposed between the rail hinge unit 310 and the slide hinge unit 320 is further included. The elastic element 340 provides two directions of repulsions, which are opposite to each other and switched at a point on a movement path of the slide hinge unit 320. Accordingly, when a user transfers the first terminal body 305 of the personal portable device by a certain distance from an initial position, a direction of the force is switched between the rail hinge unit 310 and the slide hinge unit 320 to automatically move on other paths.

For this, a first torsion spring 342 is bound with a first spring bush 342a of the first terminal body 305 and a first spring rivet 342b of the slide hinge unit 320 to rotate, and a second torsion spring 344 is bound with a second spring bush 344a of the first terminal body 305 and a second spring rivet 344b of the slide hinge unit 320 to rotate.

The second terminal body 330 is installed onto a guide frame 326 and slides on the first terminal body 305. Since the rail hinge unit 310 and the slide hinge unit 320 are substantially identical with the first embodiment and functions and effects of elements are substantially identical with the first embodiment, the description and the drawings of the previous embodiment may be referred to, and in the description of the present embodiment, duplicated parts or descriptions will be omitted.

As shown in FIG. 8, the guide rail 316a is formed on the first terminal body 305 as one body, an insertion hole 329 corresponding to a guide protrusion (not shown) of the slide hinge unit 320 is formed on the guide rail 316a, and the guide protrusion of the slide guide hinge unit 320 may be inserted into the first terminal body 305 via the insertion hole 329. Accordingly, a process of additionally assembling the guide rail 316a may be omitted via the insertion hole 329. In this case, when a large external impact occurs and crushes the guide bar or separates the guide bar 316 from the rail hinge unit 310, the guide protrusion may be closely attached to the guide rail 316a to prevent separation and may continuously slide along the guide rail 316a. In this case, since the guide protrusion may be formed identical to the first embodiment, it is possible to refer to the guide protrusion of the first embodiment.

### Embodiment 3

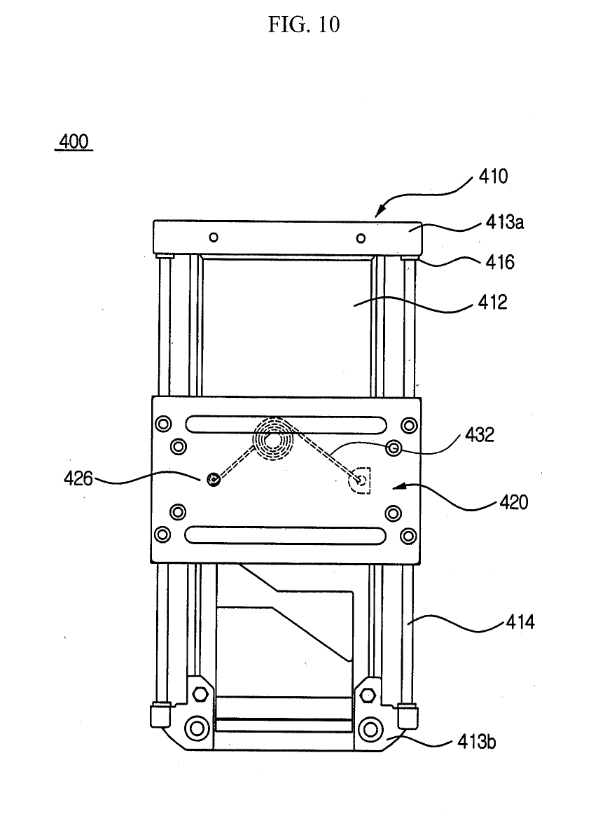

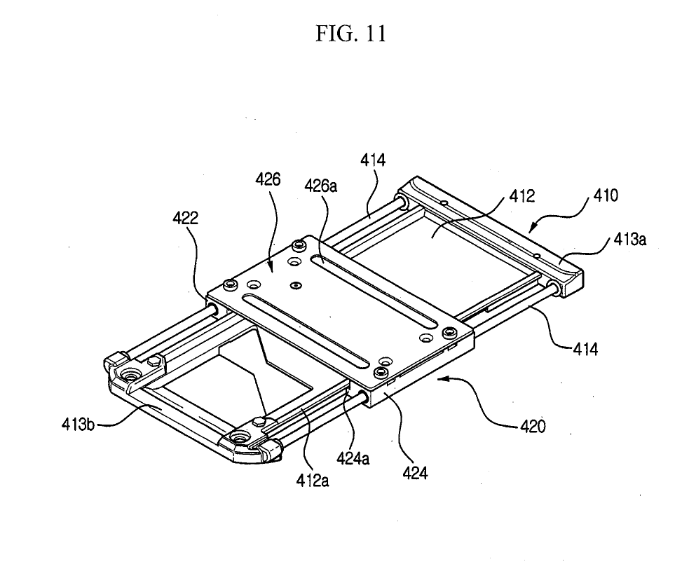

FIG. 10 is a top view illustrating a slide hinge device 400 according to a third embodiment of the present invention, and FIG. 11 is a perspective view of the slide hinge device 400 of FIG. 10.

Referring to FIGS. 10 and 11, the slide hinge device 400 includes a rail hinge unit 410, a slide hinge unit 420, and a torsion spring 432.

In a slide type personal portable device (not shown), the rail hinge unit 410 and the slide hinge unit 420 are fixed to the terminal bodies, and the terminal bodies may be open and closed by a slide type due to movement between the rail hinge unit 410 and the slide hinge unit 420 interposed between the terminal bodies. Generally, the rail hinge unit 410 is installed to a front terminal body including a display unit and the slide hinge unit 420 is installed to a rear terminal body including a keypad and a battery.

The terminal body includes components with general terminal functions and a circuit configuration. The terminal body may include a terminal case, a keypad, a display module, a wireless communication module, a battery, a microphone, and a receiver. Depending upon manufacturers, the internal configuration may be different.

The rail hinge unit 410 includes a rail plate 412 mounted on a first terminal body, an upper supporter 413a, a lower supporter 413b, and two guide bars 414 disposed parallel to a side of the rail plate 412. However, in other embodiments of the present invention, according to an intention of the designer, a plurality of guide bars may be formed.

Both ends of the rail plate 412 are bound with the upper supporter 413a and the lower supporter 413b, respectively, as one body, and inner surface may be installed to the personal portable device. The rail plate 412 may be manufactured by press processing, thereby making the rail plate 412 thin. Accordingly, in a conventional process, a slide hinge device whose thickness is 3.5 to 3.6 mm is manufactured, but in the present invention, a slide hinge device whose thickness may be reduced to 2.7 mm is manufactured. A guide sill 412a, folded twice or more to be formed in the shape of a letter L, may be formed on the side of the rail plate 412. However, in other embodiments of the present invention, according to an intention of the designer, a rail plate may be formed as one component without an upper supporter or lower supporter.

Also, the guide sill 412a is formed along a longitudinal direction on the side of the rail plate 412, adjacent to the guide bar 414. The guide sill 412a is for preventing the slide hinge unit 420 from becoming separated from the rail hinge unit 410. When the slide hinge unit 420 normally moves, the guide sill 412a is separated from the slide hinge unit 420 at a predetermined interval. Also, the guide sill 412a functions as a rib improving durability of the rail plate 412.

A damper 416 formed in the shape of a ring is provided adjacent to a connection part of the guide bar 414 and the rail plate 412. The damper 416 is for preventing an impact and noise generated when bump of the slide hinge unit 420 and the rail hinge unit 410. The damper 416 may have various cross-sections such as a circle or square. The damper 416 may be formed of crude rubber or other resins, such as conventional shock-absorbing rubber, having shock-absorbing ability. Though the conventional shock-absorbing rubber is formed in the shape of a hat and covers the end of the guide bar 414, the dampers 416 of FIGS. 10 and 11 is formed in the shape of a ring and may be controlled to be in a certain position on the guide bar 414.

The slide hinge unit 420 includes slide guides 422 and 424 and a guide frame 426.

In the slide guides 422 and 424, a penetrating hole penetrating the center of the slide guides 422 and 424 is formed in order to slide along the guide bar 414. Accordingly, the guide bar 414 directly rubs against the slide guides 422 and 424 while sliding.

In this case, when the guide bar 414 directly rubs against the slide guides 422 and 424 for a long period of time, dusts of the used material may be generated, noise may be generated, and abrasion may be generated. However, in the present invention, the slide guides 422 and 424 may be manufactured by using polyoxymethylene (POM). In this case, the POM has excellent mechanical, thermal, and chemical properties while in extended use over a wide temperature range. Also, since the POM has notably better clipping resistance and fatigue resistance than other resins and has a self-lubricating property, the POM is suitable for being used in forming the slide guides 422 and 424. However, in other embodiments, according to an intention of the designer, other self-lubricating materials such as polyamide and polyamide-imide may be substituted for the POM.

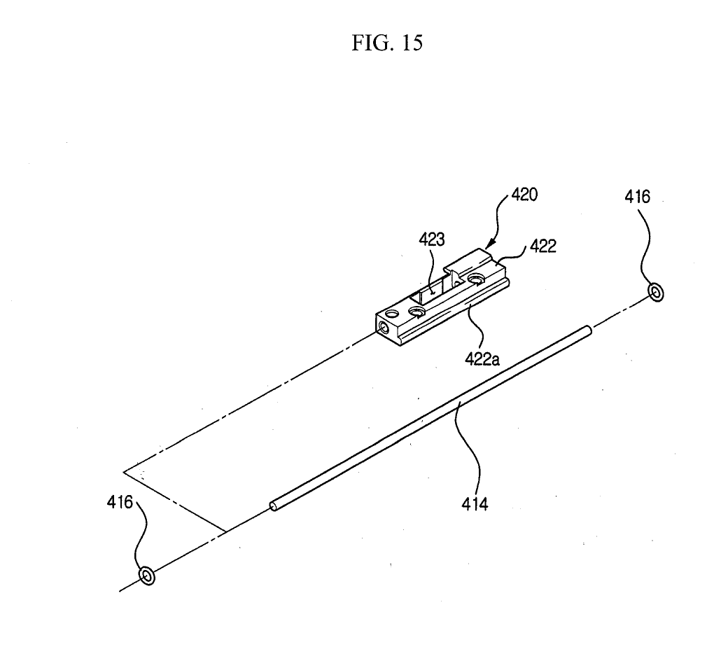

A marginal hole (shown in FIG. 15) may be provided on the top of the slide guide 422 and 424. The marginal hole 423 provides a marginal space in the slide guides 422 and 424, and the guide bar 414 vertically passes through the marginal space. The slide guides 422 and 424 may be manufactured by injection molding. In this case, in order to form the hole penetrating the slide guides 422 and 424, a core may be used. However, in actuality, it is not easy to dispose the slide guides 422 and 424 to be penetrated by one core and to take out the core without damage on moldings after molding. Accordingly, a core for injection molding may enter into both sides of the marginal hole 423 of the slide guides 422 and 424. A hole or groove is formed in the slide guides 422 and 424 by the marginal hole 423.

Also, counter to forming the guide sill 412a on the side of the rail plate 412, guide protrusions 422a and 424a are formed laterally and outwardly on a side of the slide guides 422 and 424 opposite to the guide sill 412a. Though the guide protrusions 422a and 424a may be also formed along a longitudinal direction of the slide guides 422 and 424, if discontinuously formed, the guide protrusions 422a and 424a may prevent the slide hinge unit 420 and the rail hinge unit from mutual separation.

The slide guides 422 and 424 may rotate around the guide bar 414, respectively. However, since the slide guides 422 and 424 are bound with the guide frame 426, the slide guides 422 and 424 may perform a linearly reciprocating motion along the guide bar 414. A screw hole 422b or a locking hole for other locking elements is formed on the slide guides 422 and 424 and the guide frame 426. The locking hole is formed to be protruded toward the outside by 0.1 to 0.2 mm, and is designed such that an end of a screw is not protruded from the slide guides 422 and 424 and the guide frame 426. Accordingly, after molding the rail hinge unit 410 and the slide guides 422 and 424, the slide guides 422 and 424 are bound with the guide frame 426, thereby providing the slide hinge unit 420. A groove 426a is formed lengthwise on the guide frame 426 to improve rigidity against an external impact.

As shown in FIG. 10, an elastic element interposed between the rail hinge unit 410 and the slide hinge unit 420 is further included. The elastic element provides two kinds of repulsions, which are opposite to each other and switched at a point on a movement path of the slide hinge unit 420. Accordingly, when a user transfers the first terminal body of the personal portable device by a certain distance from an initial position, a direction of the force is automatically switched between the rail hinge unit 410 and the slide hinge unit 420 to automatically move on other paths. For this, the elastic element includes a torsion spring 432. The torsion spring 432 is bound with a spring bush 418 of the rail hinge unit 410 and a spring rivet 428 of the slide hinge unit 420 to rotate. However, in other embodiments of the present invention, according to an intention of the designer, more than two torsion springs may be installed.

Hereinafter, a method of manufacturing the slide hinge device 400 of FIG. 10 will be described.

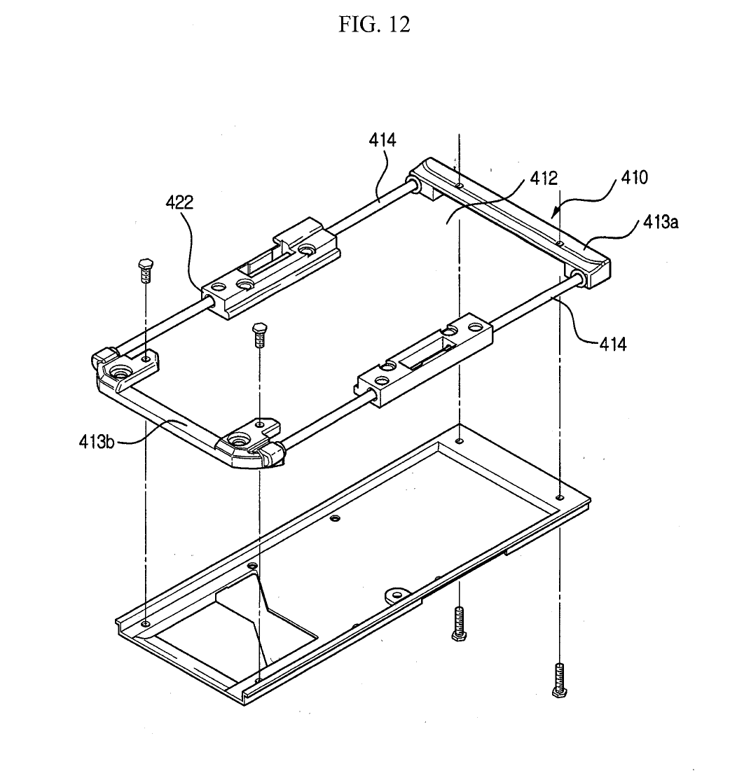

FIGS. 12 through 17 are perspective views or cross-sectional views illustrating a method of manufacturing and assembling the slide hinge device 400 of FIG. 10.

Referring to FIG. 12, the guide bar is contained in the upper supporter 413a and the lower supporter 413b via injection molding. In this case, the slide guides 422 and the damper 416 may be slipped on the guide bar 414. Since a part of an end portion of the guide bar 414 is contained in the upper supporter 413a and the lower supporter 413b via casting or injection molding, an unevenness is formed on the ends of the guide bar 414, thereby strongly fastening the guide bar to the upper supporter 413a and the lower supporter 413b. A screw for fastening the rail plate 412 is screwed from the bottom to the top of the upper supporter 413a and is screwed from the top to the bottom of the lower supporter 413b. Since the screw screwed to the upper supporter 413a is exposed while the rail hinge unit 410 and the slide hinge unit 420 slide, the screw is screwed in the direction of being installed to the terminal body. However, in other embodiments of the present invention, according to an intention of the designer, a screw may be screwed in various types.

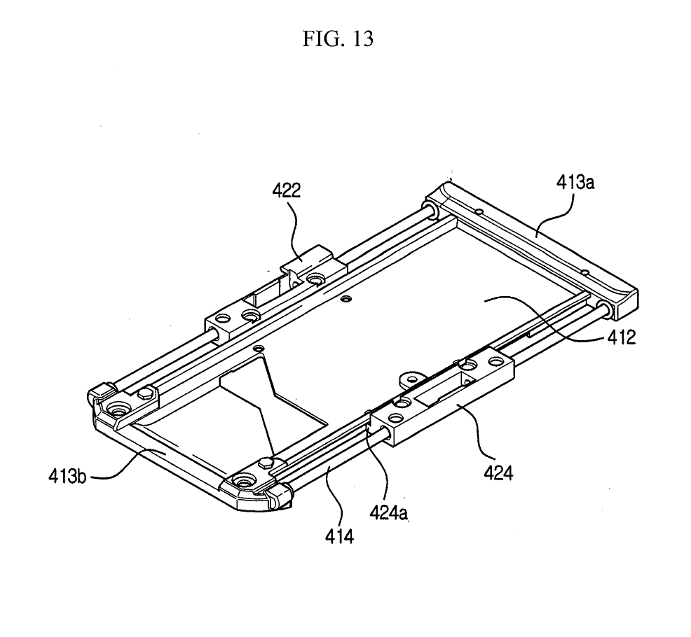

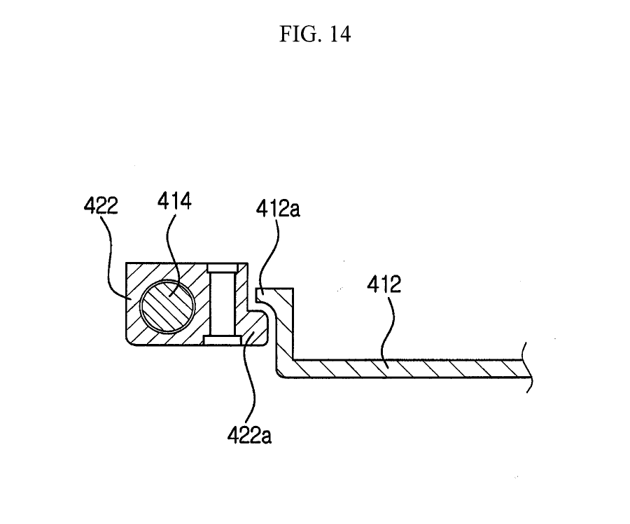

Referring to FIGS. 13 and 14, the rail plate 412 is bound with the upper supporter 413a and the lower supporter 413b as one body. In this case, the rail plate 412 may be bound with the upper supporter 413a and the lower supporter 413b by using a screw. In this case, the guide sill 412a, folded twice or more to be formed in the shape of a letter L, is formed on the side of the rail plate 412. The guide sill 412a is disposed to be engaged with the guide protrusions 422a and 424a formed on the slide guides 422 and 424, respectively. Also, the guide sill 412a functions as a rib for improving durability of the rail plate 412.

To mold the rail plate 412, a press processing may be used. Accordingly, the rail plate 412 may be formed of metal.

Referring to FIG. 15, the guide bar 414 is formed to penetrate the slide guides 422 and 424, manufactured by using self-lubricating material, and to penetrate the damper 416. Accordingly, the slide guides 422 and 424 and the damper 416 are slipped on the guide bar 414. The guide bar 414 on which the slide guides 422 and 424 and the damper 416 are slipped on is disposed in a first mold 450.

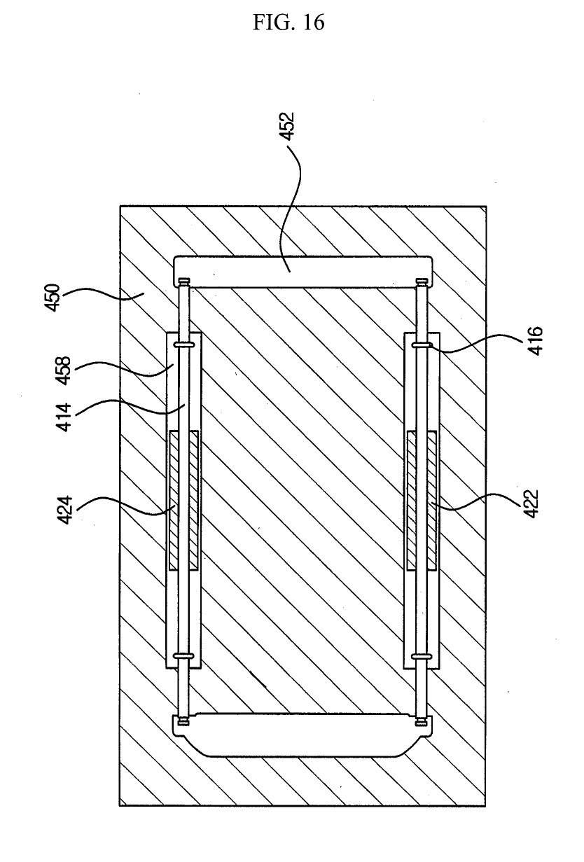

Referring to FIG. 16, the guide bar 414 is inserted into the penetration hole of the slide guides 422 and 424, and the damper 410 is slipped on both ends of the guide bar 414. The guide bar 414 and the slide guides 422 and 424 are disposed in the first mold 450. In this case, the slide guides 422 and 424 and the damper 416 formed in the shape of an O-ring are slipped on the guide bar 414 and disposed in a marginal space 458 separated from a mold space 452. In this case, the marginal space 458 is a space for temporarily protecting the damper 416 rather than a space for molding. At the beginning of a process of slipping the damper 416 on the guide bar 414, a position for disposing the damper 416 may be controlled such that the damper 416 is located in the marginal space 458.

The upper supporter 413a and the lower supporter 413b containing the both ends of the guide bar 414 may be manufactured by using injection molding in the mold space 452 of the first mold 450. The upper supporter 413a is connected to the lower supporter 413b by using the rail plate 412.

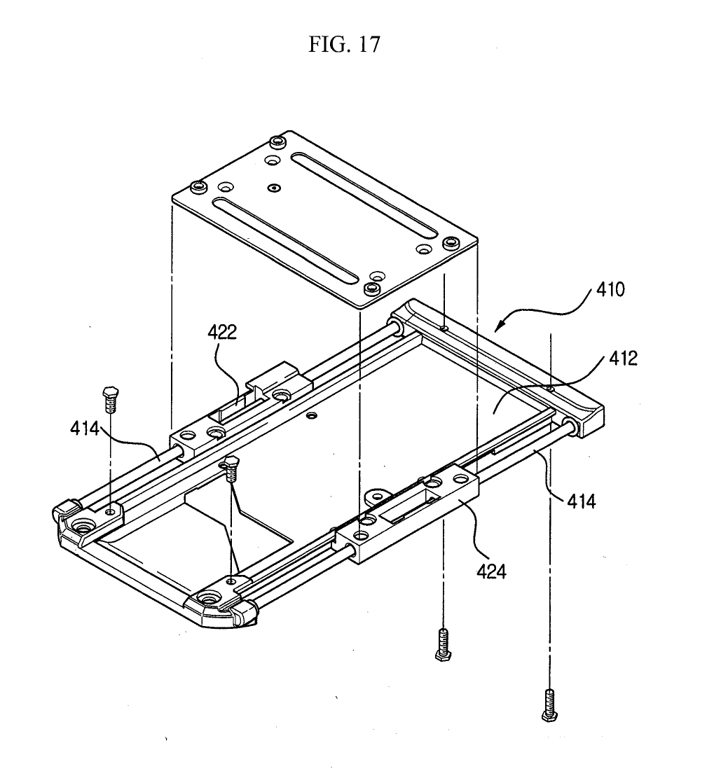

Referring to FIG. 17, the slide guides 422 and 424 are rotated to turn a combining aperture upward, and the slide guides 422 and 424 are connected to each other as one body by using the guide frame 426. The slide guides 422 and 424 form one body by the guide frame 426 and may slide according to the movement of the guide frame 426.

In this case, before or after assembling the guide frame 426, the torsion spring 432 may be interposed between the rail hinge unit 410 and the slide hinge unit 420. The torsion spring 432 is bound with a spring bush 418 of the rail hinge unit 410 and a spring rivet 428 of the slide hinge unit 420 to rotate.

As described above, after manufacturing the slide hinge device 400, the rail hinge unit 410 and the slide hinge unit 420 are installed onto the first terminal body and second terminal body of the personal portable device, respectively. The first and second terminal bodies are attached by the slide hinge device 400. The rail hinge unit 410 and the slide hinge unit 420 move relative to each other by using the guide bar 414, thereby providing stable movement.

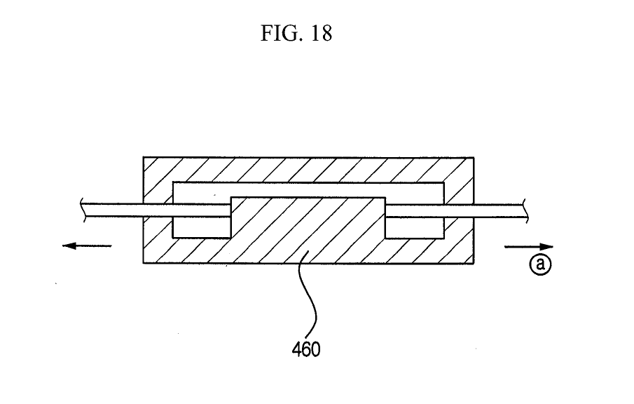

FIG. 18 is a cross-section view illustrating a second mold for manufacturing slide guides according to an embodiment of the present invention.

Referring to FIG. 18, the slide guides 422 and 424 may be injection molded by using a second mold 460. In the second mold 460, since a part is protruded toward the inside of a mold space, the marginal hole 423 may be formed on the slide guides 422 and 424 in the injection molding. A core enters into both sides of the marginal hole 423 to form a penetration hole for the guide bar 414 on the slide guides 422 and 424 â. Accordingly, since the slide guides 422 and 424 have an area contacting the second mold 460 relatively broader than the conventional, material of the slide guides 422 and 424 may be quickly cooled, thereby increasing productivity of the slide guides 422 and 424. However, in other embodiments of the present invention, according to an intention of the designer, a marginal hole may be omitted on slide guides.

Accordingly, in the slide hinge device according to the present embodiment, since the upper supporter 413a and the lower supporter 413b are injection molded to contain the both ends of the guide bar 414, there is no burden associated with an error in dimensions and a manufacturing process is convenient. The rail plate 412 is manufactured by press processing, thereby making a thin rail plate.

Also, since the slide hinge device is manufactured by using self-lubricating material, a feel of sliding is improved and a dust is not generated. Since the slide hinge device may use the POM, the slide hinge device has excellent mechanical, thermal, and chemical properties, and has better clipping resistance and fatigue resistance than a conventional hinge device.

Also, before or after fastening the guide frame 426, the torsion spring is installed to add a semi-automatic opening and closing function.

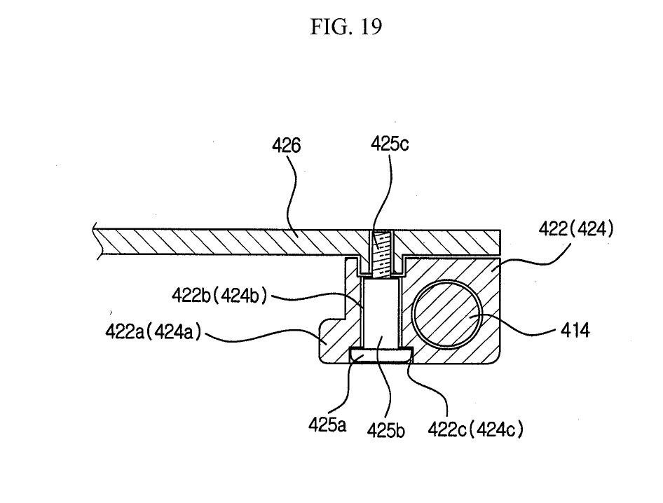

FIG. 19 is a partial cross-sectional view illustrating a screw hole of the slide guide according to the third embodiment of the present invention.

Referring to FIG. 19, screw holes 422b and 424b for locking the guide frame 426 may be formed on the slide guides 422 and 424. In this case, at an entrance of the screw holes 422b and 424b, counter-bores 422c and 424c for supporting the head of a screw 425 are formed. The screw 425 includes a screw head 425a, a screw body 425b having a diameter smaller than the screw head 425a, and a thread portion 425c formed in the end of the screw body 425b. Since the screw 425 may be a double step screw and is not locked inside the guide frame 426 more than required, damage of the slide guides 422 and 424 due to adding unnecessary force may be prevented and deformation of the screw hole 422b and 424b may be prevented. However, in other embodiments of the present invention, according to an intention of the designer, the shape of guide frame and slide guide may be variously established corresponding to the screw.

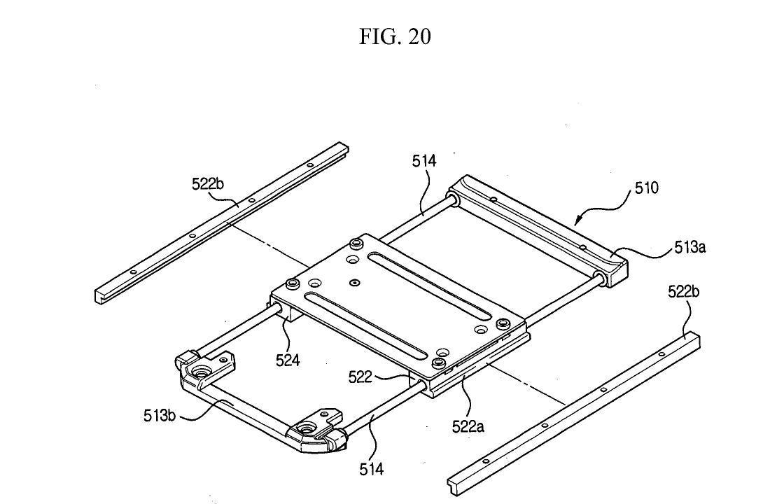

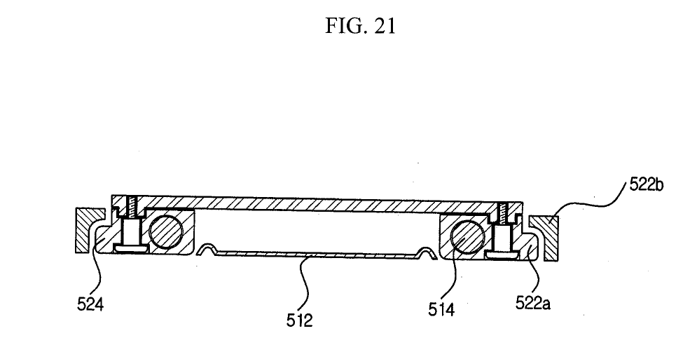

FIG. 20 is a perspective view illustrating a slide hinge device according to another embodiment of the present invention, and FIG. 21 is a cross-sectional view illustrating the slide hinge device of FIG. 20.

Referring to FIGS. 20 and 21, a guide sill 522a protruded toward the outside is formed on slide guides 522 and 524. In this case, the guide sill 522a may be continuously provided. However, in other embodiments of the present invention, according to an intention of the designer, the guide sill 522a may be discontinuously provided.

A guide rail 522b is installed to both sides of a first terminal body, and the guide sill 522a may be positioned to be close to the guide rail 522b. Accordingly, the slide hinge device becoming separated from the terminal body is prevented.

In this case, protrusions looking upward may be formed on the sides of the rail plate 512 by press process, and the rail plate 512 connects an upper supporter 513a and the lower supporter 513b as one body. Accordingly, a durability of the rail plate 512 may be improved by the protrusions. In this case, instead of forming the protrusion by pressing, the side of the rail plate 512 may be bent toward the top or bottom to function as a rib. In other embodiments of the present invention, the groove may be variously changed in shape.

In the rail plate 512, an elastic element is installed to semi-automatically slide. However, in other embodiments of the present invention, according to an intention of the designer, a rail plate is manufactured as one body with a first terminal body such that the first terminal body and a slide hinge device may be assembled by one process.

### INDUSTRIAL APPLICABILITY

The slide hinge device of the present invention is very economical because manufacturing is easy, a number of processes for manufacturing may be reduced, and a defect rate may be reduced.

Also, since, after manufacturing, dimension is passively fitted, a defect due to an error of dimension may be prevented and a efficiency similar to precision engineering may be acquired.

Also, since the slide hinge device is manufactured by using self-lubricating material, a feel of sliding is improved and a dust is not generated. Also, since the slide hinge device may be formed of the POM, the slide hinge device has excellent mechanical, thermal, and chemical properties, and has better clipping resistance and fatigue resistance than a conventional hinge device.

Also, since a slide hinge unit slides along a guide bar, slide sensitivity is excellent. Before or after fastening a guide frame, a torsion spring is installed to add a semi-automatic opening and closing function.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A slide hinge device comprising:
a rail hinge unit including an upper supporter, a lower supporter separated from the upper supporter by a predetermined distance, and at least one guide bar bound with the upper supporter and the lower supporter; and
a slide hinge unit including a slide guide, in which a penetration hole corresponding to the at least one guide bar is formed, for sliding along the guide bar and a guide frame bound with the slide guide as one body.

2. The device of claim 1, wherein the slide hinge unit further includes a moving bush sliding along the guide bar.

3. The device of claim 1, wherein the slide guide is formed of lubricating material.

4. The device of claim 1, further comprising an elastic element interposed between the rail hinge unit and the slide hinge unit, the elastic element providing two repulsion forces, which are opposite to each other and switched at a point on a movement path of the slide hinge unit.

5. The device of claim 1, wherein a damper in a shape of an O-ring containing the guide bar is provided in a connection part of the guide bar and the rail plate.

6. A slide hinge device comprising:
a rail hinge unit including an upper supporter, a lower supporter separated from the upper supporter by a predetermined distance, and at least one guide bar bound with the upper supporter and the lower supporter; and
a slide hinge unit including a moving bush sliding along the guide bar, a slide guide formed in one body with the moving bush, and a guide frame formed in one body with the slide guide.

7. The device of claim 6, wherein:
a guide rail is formed lengthwise, adjacent to a side of the slide hinge unit; and
a guide protrusion corresponding to the guide rail is formed on the slide guide.

8. The device of claim 6, wherein:
two ends of the guide bar are contained in the upper supporter and the lower supporter respectively; and
an unevenness is formed on the ends of the guide bar.

9. A slide hinge device comprising:
a rail hinge unit including an upper supporter, a lower supporter separated from the upper supporter by a predetermined distance, and at least one guide bar vertically disposed between the upper supporter and the lower supporter; and
a slide hinge unit, in which a penetration hole corresponding to the guide bar is formed, including a slide guide formed of lubricating material and a guide frame bound with the slide guide as one body.

10. The device of claim 9, wherein the rail hinge unit further includes a rail plate interposed between the upper supporter and the lower supporter.

11. The device of claim 10, wherein the rail plate is formed as one body with the upper supporter and the lower supporter.

12. The device of claim 10, wherein:
a guide sill formed in the shape of a letter of L by being bent at least twice is formed on the side of the rail plate, and
a guide protrusion corresponding to the guide sill is formed on the slide guide.

13. The device of claim 9, wherein a guide protrusion is formed laterally and outwardly on a side of the slide guide, the guide protrusion is provided close to a guide rail provided adjacent to a side of the slide hinge unit.

14. The device of claim 9, wherein the slide guide is formed by using one of polyoxymethylene, polyamide, and polyamide-imide.

15. The device of claim 9, wherein:
a marginal space is formed in the slide guide; and
two concentric holes for the guide bar are formed in both sides of the slide guide around the marginal space.

16. The device of claim 9, wherein:
a screw hole for binding the guide frame is formed in the slide guide; and
a counter-bore for receiving and supporting the head of a screw is formed at an entrance of the screw hole,
wherein the screw is a double step screw including a screw head, a screw body having a diameter smaller than the screw head for the screw hole, and a thread portion formed in an end of the screw body, the thread portion engaged with the guide frame.

17. A personal portable terminal comprising:
a first terminal body;
a rail hinge unit including an upper supporter, a lower supporter separated from the upper supporter by a predetermined distance, and at least one guide bar bound with the upper supporter and the lower supporter;
a slide hinge unit including a slide guide, in which a penetration hole corresponding to the guide bar is formed in a center thereof, for sliding along the guide bar and a guide frame bound with the slide guide as one body; and
a second terminal body installed to the guide frame and sliding on the first terminal body.

18. The terminal of claim 17, wherein the slide guide further includes a moving bush sliding along the guide bar.

19. The terminal of claim 17, further comprising an elastic element interposed between the rail hinge unit and the slide hinge unit, the elastic element providing two repulsion forces, which are opposite to each other and switched at a point on a movement path of the slide hinge unit.

20. The device of claim 17, wherein a damper in a shape of an O-ring containing the guide bar is provided in a connection part of the guide bar and the rail plate.

21. The device of claim 17, wherein:
a guide rail is formed lengthwise, adjacent to a side of the slide hinge unit; and
a guide protrusion corresponding to the guide rail is formed on the slide guide.

22. The device of claim 21, wherein an interval for inserting the guide protrusion is formed between two separate guide rails, to pass the slide hinge unit to the first terminal body.

23. The device of claim 17, wherein:
two ends of the guide bar are contained in the upper supporter and the lower supporter respectively; and
an unevenness is formed on the both ends of the guide bar.

24. The device of claim 17, wherein the slide guide is formed of a self-lubricating material.

25. The device of claim 24, wherein the slide guide is formed by using one of polyoxymethylene, polyamide, and polyamide-imide.

26. The device of claim 17, wherein the rail hinge unit further includes a rail plate interposed between the upper supporter and the lower supporter.

27. The device of claim 26, wherein the rail plate is formed as one body with the upper supporter and the lower supporter.

28. The device of claim 26, wherein a guide protrusion is formed laterally and outwardly on a side of the slide guide, the guide protrusion is provided close to a guide rail provided adjacent to the side of the slide hinge unit.

29. The device of claim 17, wherein:
a marginal space is formed in the slide guide; and
two concentric holes for the guide bar are formed in both sides of the slide guide around the marginal space.

30. The device of claim 17, wherein:
a screw hole for binding the guide frame is formed in the slide guide; and
a counter-bore for receiving and supporting the head of a screw is formed at an entrance of the screw hole,
wherein the screw is a double step screw including a screw head, a screw body having a diameter smaller than the screw head for the screw hole, and a thread portion formed in an end of the screw body, the thread portion engaged with the guide frame.

31. A method of manufacturing a slide hinge device, comprising:
providing a guide bar and a moving bush containing the guide bar, the moving bush capable of sliding along the guide bar;
disposing the guide bar and the moving bush in a mold; and
molding a rail hinge unit including an upper supporter and lower supporter containing both ends of the guide bar and a slide hinge unit containing the moving bush by using the mold.

32. The method of claim 31, wherein, in the molding a rail hinge unit and a slide hinge unit containing the moving bush by using the mold, a first mold cavity for the upper supporter, a second mold cavity for the lower supporter, and a third mold cavity for the slide hinge unit are provided, the first through third mold cavities being separated, respectively.

33. A method of manufacturing a slide hinge device, comprising:
providing a guide bar and a slide guide, in which a penetration hole corresponding to the guide bar is formed, formed of lubricating material;
disposing the guide bar and the slide guide in a first mold;
molding an upper supporter and lower supporter containing both ends of the guide bar, by using the first mold;
binding the upper supporter with the lower supporter by using a rail plate; and
binding the slide guide with a guide frame as one body.

34. The method of claim 33, wherein the slide guide is injection molded in a mold cavity by using a second mold, the slide guide formed of lubricating material.

35. The method of claim 34, wherein:
the second mold including a protrusion for forming a predetermined marginal space in the slide guide; and
two cores penetrate inwardly from both sides of the second mold around the marginal space to form two concentric holes for the guide bar in the slide guide.

36. The method of claim 33, wherein an elastic element is interposed between the rail hinge unit and the slide hinge unit to provide two repulsion forces, which are opposite to each other and switched at a point on a movement path of the slide hinge unit.

37. The method of claim 33, wherein the slide hinge unit and a damper in a shape of an O-ring are slipped on the guide bar, the damper disposed in a peripheral available space separated from the mold when molding the rail hinge unit.
